(19) United States
(12) Patent Application Publication
(10) Pub. No.: US 2016/0300539 A1
(43) Pub. Date: Oct. 13, 2016

(54) IMAGE DISPLAYING METHOD, DISPLAY APPARATUS AND OPERATING METHOD THEREOF

(71) Applicant: AU OPTRONICS CORP., Hsin-Chu (TW)

(72) Inventors: HSING-JU CHEN, Hsin-Chu (TW); YUNG-JEN CHEN, Hsin-Chu (TW)

(21) Appl. No.: 14/739,520

(22) Filed: Jun. 15, 2015

(30) Foreign Application Priority Data
Apr. 9, 2015 (TW) 104111498

(51) Int. Cl. G09G 3/36

(52) U.S. Cl. CPC G09G 3/3648; G09G 2310/08

(57) ABSTRACT

A display apparatus includes a display panel, a gate driving unit and a timing control unit. The timing control unit receives an image signal composed of display data of a plurality of successive images. Each image has a standard grayscale and is composed of a plurality of sub-frames which are adjacent sequentially in time and have same display content. The sub-frames of each image include at least one first sub-frame and at least one second sub-frame. The first and the second sub-frames have different grayscales. The timing control unit further determines whether the successive images are for displaying a dynamic pattern or not. If yes, the timing control unit controls the gate driving unit to drive the display panel at a first frame update frequency, alternatively, if no, drive the display panel at a second frame update frequency, which is greater than the first frame update frequency.

### TECHNICAL FIELD

The present disclosure relates to an image displaying method, a display apparatus and an operating method thereof, and more particularly to an image displaying method, a display apparatus and an operating method thereof able to adjust a frame update frequency according to an image signal.

### BACKGROUND

Liquid crystal display apparatus controls the rotation angle of liquid crystals according to the images to be displayed, so that light at different angles can display images on the liquid crystal display apparatus through polarizing elements. However, when a user watches a liquid crystal display apparatus at a squint angle, the color washout issue may occur due to that the angle between the user and the liquid crystal display apparatus is not located in the viewing angle of the liquid crystal display apparatus; and consequentially, a poor visual effect is resulted.

### SUMMARY

The present disclosure provides a display apparatus, which includes a display panel, a gate driving unit and a timing control unit. The gate driving unit is electrically coupled to the display panel. The timing control unit, electrically coupled to the display panel and the gate driving unit, is configured to receive an image signal composed of display data of a plurality of successive images. Each image has a standard grayscale and is composed of a plurality of sub-frames which are adjacent sequentially in time and have same display content. The plurality of sub-frames of each image includes at least one first sub-frame and at least one second sub-frame. The first sub-frame and the second sub-frame have different grayscales. The timing control unit is further configured to determine whether the successive images are for displaying a dynamic pattern or not. If yes, the timing control unit controls the gate driving unit to drive the display panel at a first frame update frequency. If no, the timing control unit controls the gate driving unit to drive the display panel at a second frame update frequency, wherein the second frame update frequency is greater than the first frame update frequency.

The present disclosure further provides an operating method of a display apparatus. The display apparatus includes a display panel, a gate driving unit and a timing control unit. The gate driving unit is electrically coupled to the display panel. The timing control unit is electrically coupled to the display panel and the gate driving unit and configured to receive an image signal composed of display data of a plurality of successive images. Each image has a standard grayscale and is composed of a plurality of sub-frames which are adjacent sequentially in time and have same display content. The plurality of sub-frames of each image includes at least one first sub-frame and at least one second sub-frame. The first sub-frame and the second sub-frame have different grayscales. The operating method of a display apparatus includes steps of: configuring the timing control unit to determine whether the images are for displaying a dynamic pattern or not; if yes, configuring the timing control unit to control the gate driving unit to drive the display panel at a first frame update frequency; and if no, configuring the timing control unit to control the gate driving unit to drive the display panel at a second frame update frequency, wherein the second frame update frequency is greater than the first frame update frequency.

The present disclosure still further provides an image displaying method applied to an image signal. The image signal is composed of display data of a plurality of successive images. Each image has a standard grayscale and is composed of a plurality of sub-frames which are adjacent sequentially in time and have same display content. The plurality of sub-frames of each image includes at least one first sub-frame and at least one second sub-frame. The first sub-frame and the second sub-frame have different grayscales. The image displaying method includes steps of: determining whether the images are for displaying a dynamic pattern or not; if yes, displaying the images at a first frame update frequency; and if no, displaying the images at a second frame update frequency, wherein the second frame update frequency is greater than the first frame update frequency.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic diagram of a display apparatus 10 in accordance with an embodiment of the present disclosure;

FIG. 2A is a structural diagram of an image in accordance with an embodiment of the present disclosure;

FIG. 2B is a structural diagram of an image in accordance with another embodiment of the present disclosure;

FIG. 3A is a structural diagram of an image in accordance with still another embodiment of the present disclosure;

FIG. 3B is a structural diagram of an image in accordance with yet another embodiment of the present disclosure;

FIG. 4 is a flowchart of an operating method of a display apparatus in accordance with an embodiment of the present disclosure; and

FIG. 5 is a flowchart of an image displaying method in accordance with an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

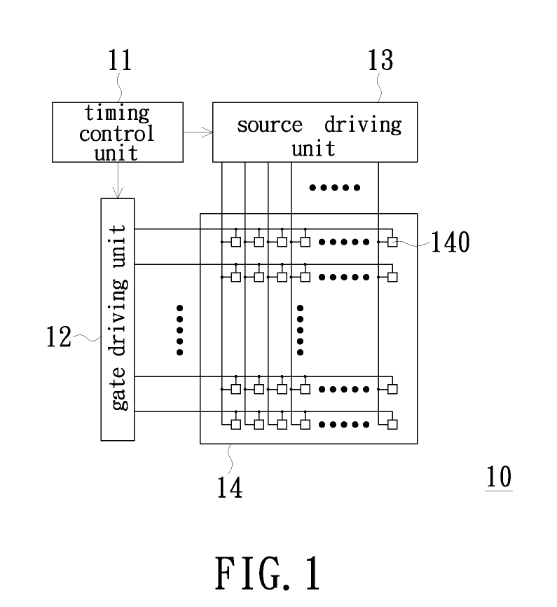

Please refer to FIG. 1, which is a schematic diagram of a display apparatus 10 in accordance with an embodiment of the present disclosure. As shown in FIG. 1, the display apparatus 10 in the present embodiment includes a timing control unit (TCON) 11, a gate driving unit 12, a source driving unit 13 and a display panel 14. The timing control unit 11 is electrically coupled to the gate driving unit 12 and the source driving unit 13. The display panel 14 includes a plurality of pixel units 140, and each pixel unit 140 is electrically coupled to the gate driving unit 12 and the source driving unit 13.

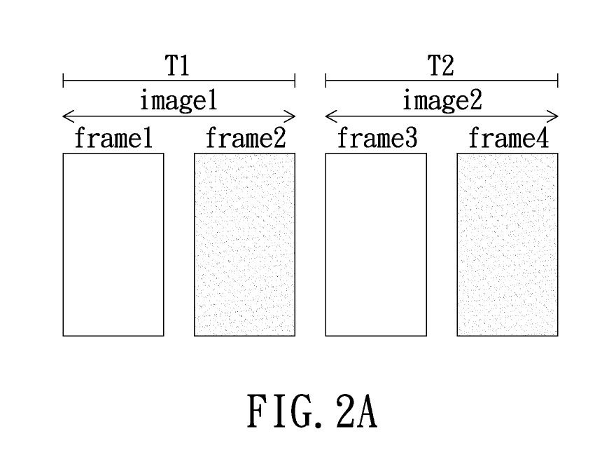

The following, in conjunction with FIGS. 2A and 2B, describes an operation of the abovementioned display apparatus 10 in accordance with an embodiment of the present disclosure. The timing control unit 11 is configured to receive an image signal, which is composed of the display data of a plurality of successive images. For example, as shown in FIG. 2A and 2B, the image signal is composed of the display data of the first image image1 and the second image image2; however, the present disclosure is not limited thereto. The first image image1 and the second image image2 are each provided with a standard grayscale. Specifically, the first image image1 and the second image image2 are each composed of a plurality of sub-frames (for example, at least one first sub-frame and at least one second sub-frame), which are adjacent sequentially in time and have the same display content. The first sub-frame and the second sub-frame have different grayscales and are used to facilitate the oblique angle of the display panel 14 to display images having the abovementioned standard grayscale. For example, as illustrated in FIG. 2A, the first image image1 has a first sub-frame frame1 and a second sub-frame frame2 which are adjacent with each other, and the second image image2 has a third sub-frame frame3 and a fourth sub-frame frame4 which are adjacent with each other; however, the present disclosure is not limited thereto. The grayscale of the first sub-frame frame1 is different from that of the second sub-frame frame2 and the grayscale of the third sub-frame frame3 is different from that of the fourth sub-frame frame4. In the present embodiment, the grayscale of the first sub-frame frame1 is greater than that of the second sub-frame frame2 and the grayscale of the third sub-frame frame3 is greater than that of the fourth sub-frame frame4. In addition, the grayscales of the first sub-frame frame1 and the second sub-frame frame2 satisfy a particular gamma curve characteristic and the grayscales of the third sub-frame frame3 and the fourth sub-frame frame4 satisfy a particular gamma curve characteristic, such as gamma 2.2.

The timing control unit 11 is further configured to determine whether the two adjacent images (or the last sub-frame in one image and the first sub-frame in the followed image) have the same display content or not, thereby determining whether the two adjacent images are used for displaying a dynamic pattern. In one embodiment, the timing control unit 11 uses overdrive function or similar mechanisms to determine whether the two successive images have the same display content or not. Specifically, if it is determined that the two successive images are used for displaying a dynamic pattern (that is, the two successive images have different display contents), the timing control unit 11 controls the gate driving unit 12 to drive the display panel 14 at a first frame update frequency. Alternatively, if it is determined that the two successive images are used for displaying a non-dynamic pattern (that is, the two successive images have the same display content), the timing control unit 11 controls the gate driving unit 12 to drive the display panel 14 at a second frame update frequency; wherein the second frame update frequency is greater than the first frame update frequency. In one embodiment, the second frame update frequency is greater than or equal to 150 Hz, which is a limited frequency that human eyes will not sense the image blinking

For example, as shown in FIG. 2A, when it is determined that the adjacent second image image2 and the first image image1 (or, the third sub-frame frame3 in the second image image2 and the second sub-frame frame2 in the first image image1) have different displaying contents, the timing control unit 11 determines that the second image image2 is a dynamic pattern and controls the gate driving unit 12 to drive the plurality of pixel units 140 of the display panel 14 at the first frame update frequency within the display period of the second image image2 (that is, the period T2 in FIG. 2A). In other words, the third sub-frame frame3 and the fourth sub-frame frame4 of the second image image2 are displayed at the first frame update frequency within the display period of the second image image2 when the timing control unit 11 determines that the second image image2 is a dynamic pattern. As shown in FIG. 2B, when it is determined that the adjacent second image image2 and the first image image1 (or, the third sub-frame frame3 in the second image image2 and the second sub-frame frame2 in the first image image1) have the same displaying content, the timing control unit 11 determines that the second image image2 is a non-dynamic pattern and controls the gate driving unit 12 to drive the plurality of pixel units 140 of the display panel 14 at the second frame update frequency within the display period of the second image image2 (that is, the period T2 in FIG. 2B). In other words, the third sub-frames frame3 and the fourth sub-frames frame4 of the second image image2 are displayed at the second frame update frequency within the display period of the second image image2 when the timing control unit 11 determines that the second image image2 is a non-dynamic pattern.

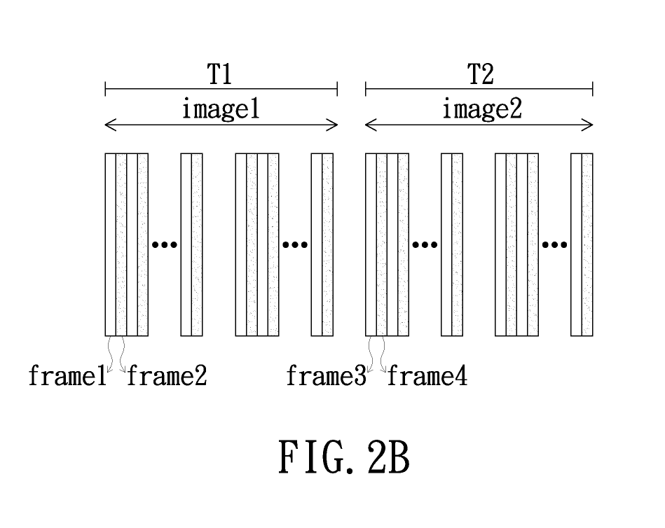

In another embodiment, each image may be composed of three sub-frames. For example, as illustrated in FIG. 3A, the image image3 is composed of a first sub-frame frame1, a second sub-frame frame2 and a third sub-frame frame3, which are sequentially adjacent in time and have the same display content; however, the present disclosure is not limited thereto. Specifically, in the present embodiment, the grayscale of the first sub-frame frame1 is greater than that of the second sub-frame frame2 and that of the third sub-frame frame3. In addition, the grayscales of the first sub-frame frame1, the second sub-frame frame2 and the third sub-frame frame3 satisfy a particular gamma curve characteristic.

In still another embodiment, each image may be composed of four sub-frames. For example, as illustrated in FIG. 3B, the image image4 is composed of a first sub-frame frame1, a second sub-frame frame2, a third sub-frame frame3 and a fourth sub-frame frame4, which are sequentially adjacent in time and have the same display content; however, the present disclosure is not limited thereto. Specifically, in the present embodiment, the grayscale of the first sub-frame frame1 is greater than that of the second sub-frame frame2, that of the third sub-frame frame3 and that of the fourth sub-frame frame4. In addition, the grayscales of the first sub-frame frame1, the second sub-frame frame2, the third sub-frame frame3 and the fourth sub-frame frame4 satisfy a particular gamma curve characteristic.

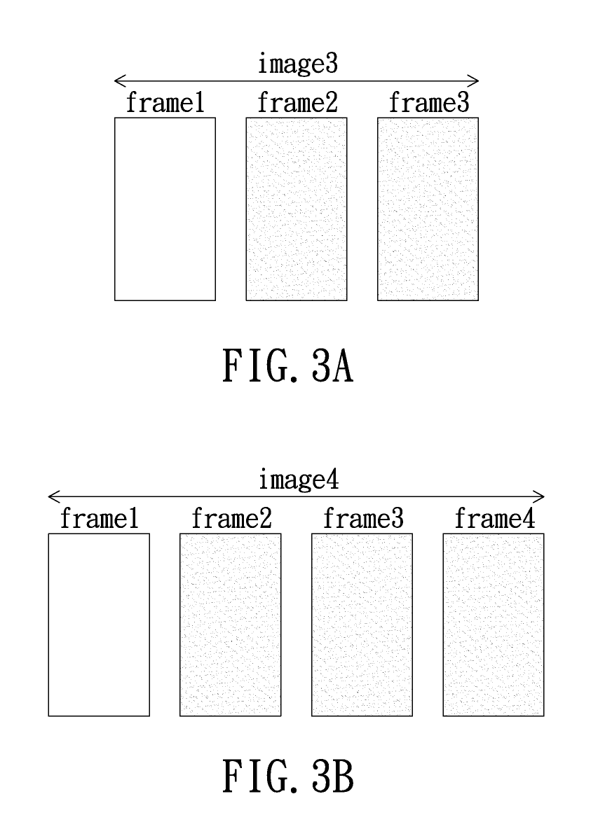

According to the above-described content, an operating method of a display apparatus is provided in the present disclosure. Please refer to FIG. 4, which is a flowchart of an operating method of the display apparatus 10 in accordance with an embodiment of the present disclosure. As shown in FIG. 4, the operating method in the present embodiment includes steps of: configuring the timing control unit 11 to receive an image signal composed of the display data of a plurality of successive images and configuring the timing control unit 11 to determine whether the adjacent images have the same display content or not, thereby determining whether the adjacent images are used for displaying a dynamic pattern or not (step S401); if yes, configuring the timing control unit 11 to controls the gate driving unit 12 to drive the display panel 14 at a first frame update frequency (step S402); alternatively, if no, configuring the timing control unit 11 to control the gate driving unit 12 to drive the display panel 14 at a second frame update frequency (step S403), wherein the second frame update frequency is greater than the first frame update frequency.

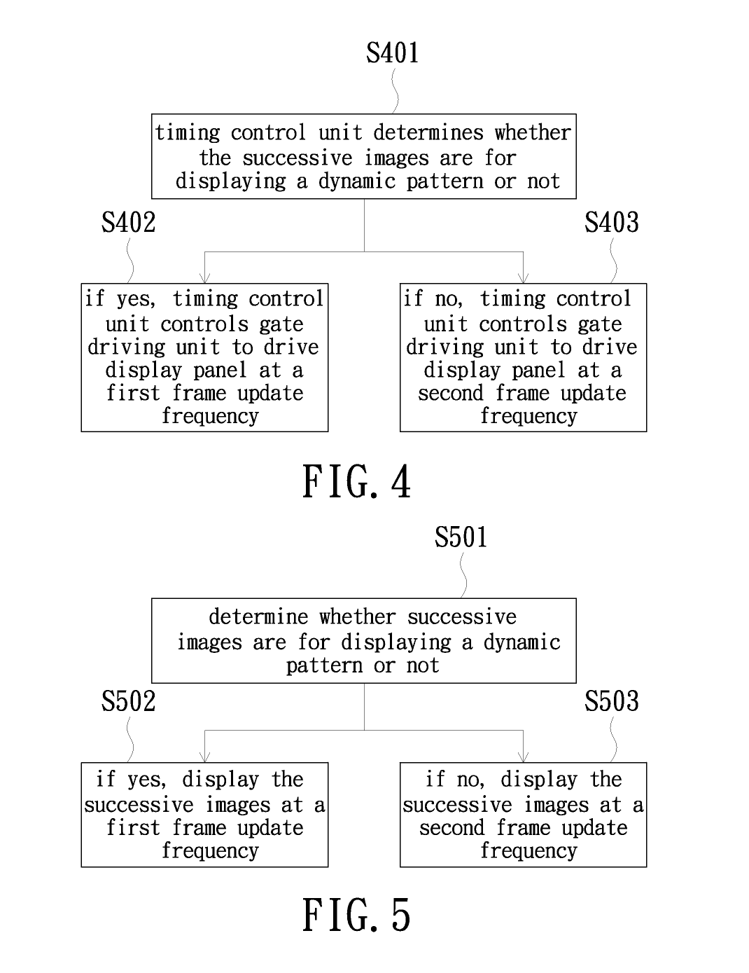

According to the above-described content, an image displaying method is provided in the present disclosure. Please refer to FIG. 5, which is a flowchart of an image displaying method in accordance with an embodiment of the present disclosure. As shown in FIG. 5, the image displaying method in the present embodiment includes steps of: determining whether two successive images are used for displaying a dynamic pattern (step S501); if yes, displaying images at a first frame update frequency (step S502); if no, displaying images at a second frame update frequency (step S503), wherein the second frame update frequency is greater than the first frame update frequency.

In summary, each image in the present disclosure has at least one first sub-frame and at least one second sub-frame and the two sub-frames have different grayscales; thus, the liquid crystal elements in the display apparatus keep rotating with the different sub-frames in the display period of each image, so a user at any viewing angle can watch images with the standard grayscale without the color washout issue. In addition, by driving the display panel at the lower first frame update frequency when it is determined that the images are for a dynamic pattern and driving the display panel at the higher second frame update frequency when it is determined that the images are for a non-dynamic pattern, the smear issue is avoided while a dynamic pattern is being displayed. Further, because the second frame update frequency is greater than the frequency range that human eyes can sense the image blinking, the image blinking is avoided while a non-dynamic pattern is being displayed. Therefore, the display apparatus of the present disclosure has improved visual effect.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus, comprising:
a display panel;
a gate driving unit, electrically coupled to the display panel; and
a timing control unit, electrically coupled to the display panel and the gate driving unit, configured to receive an image signal composed of display data of a plurality of successive images, wherein each image has a standard grayscale and is composed of a plurality of sub-frames which are adjacent sequentially in time and have a same display content, the plurality of sub-frames of each image comprises at least one first sub-frame and at least one second sub-frame, the first sub-frame and the second sub-frame have different grayscales,
wherein the timing control unit is further configured to determine whether the successive images are for displaying a dynamic pattern or not, if yes, the timing control unit controls the gate driving unit to drive the display panel at a first frame update frequency, if no, the timing control unit controls the gate driving unit to drive the display panel at a second frame update frequency, wherein the second frame update frequency is greater than the first frame update frequency.

2. The display apparatus according to claim 1, wherein the second frame update frequency is greater than or equal to 150 Hz.

3. The display apparatus according to claim 1, wherein the timing control unit determines whether the successive images are for displaying the dynamic pattern or not through determining whether the successive images have the same display content.

4. The display apparatus according to claim 1, wherein the first sub-frame and the second sub-frame are used to facilitate an oblique angle of the display panel to display the images having the standard grayscale.

5. An operating method of a display apparatus, the display apparatus comprising a display panel, a gate driving unit and a timing control unit, the gate driving unit being electrically coupled to the display panel, the timing control unit being electrically coupled to the display panel and the gate driving unit and configured to receive an image signal composed of display data of a plurality of successive images, each image having a standard grayscale and being composed of a plurality of sub-frames which are adjacent sequentially in time and have a same display content, the plurality of sub-frames of each image comprising at least one first sub-frame and at least one second sub-frame, the first sub-frame and the second sub-frame having different grayscales, the operating method of a display apparatus comprising:
configuring the timing control unit to determine whether the images are for displaying a dynamic pattern or not;
if yes, configuring the timing control unit to control the gate driving unit to drive the display panel at a first frame update frequency; and
if no, configuring the timing control unit to control the gate driving unit to drive the display panel at a second frame update frequency, wherein the second frame update frequency is greater than the first frame update frequency.

6. The operating method according to claim 5, wherein the second frame update frequency is greater than or equal to 150 Hz.

7. The operating method according to claim 5, wherein the timing control unit determines whether the successive images are for displaying the dynamic pattern or not through determining whether the successive images have the same display content.

8. The operating method according to claim 5, wherein the first sub-frame and the second sub-frame are used to facilitate an oblique angle of the display panel to display the images having the standard grayscale.

9. An image displaying method applied to an image signal, the image signal being composed of display data of a plurality of successive images, each image having a standard grayscale and being composed of a plurality of sub-frames which are adjacent sequentially in time and have a same display content, the plurality of sub-frames of each image comprising at least one first sub-frame and at least one second sub-frame, the first sub-frame and the second sub-frame having different grayscales, the image displaying method comprising:
determining whether the images are for displaying a dynamic pattern or not;
if yes, displaying the images at a first frame update frequency; and
if no, displaying the images at a second frame update frequency, wherein the second frame update frequency is greater than the first frame update frequency.

10. The image displaying method according to claim 9, wherein the second frame update frequency is greater than or equal to 150 Hz.

11. The image displaying method according to claim 9, wherein the determination of whether the images are for displaying a dynamic pattern or not is realized by determining whether the images have the same display content.

12. The image displaying method according to claim 9, wherein the first sub-frame and the second sub-frame are used to facilitate an oblique angle of the display panel to display the images having the standard grayscale.
